(19) United States
(12) Patent Application Publication
(10) Pub. No.: US 2007/0098071 A1
(43) Pub. Date: May 3, 2007

(54) Picture coding device, method, and program thereof

(76) Inventor: Hideyuki Ohgose, Osaka (JP)

Correspondence Address: MCDERMOTT WILL & EMERY LLP, 600 13TH STREET, N.W., WASHINGTON, DC, 20005-3096, US

(21) Appl. No.: 11/588,327

(22) Filed: Oct. 27, 2006

(30) Foreign Application Priority Data
Oct. 31, 2005 (JP) 2005-317366

(51) Int. Cl. H04N 7/12; H04B 1/66

(52) U.S. Cl. 375/240.12; 375/240.27

(57) ABSTRACT

The present invention provides a picture coding device which reduces the amount of coded data by coding picture data using the H.264 standard. The picture coding device includes: a picture extension unit that generates an extended picture by extending an input picture using a reference value defined to be used when adjacent pixels do not exist in performing intra prediction according to the H.264 standard; and a coding unit that generates a code which represents a prediction error in the extended lines with 0 by coding, using intra prediction according to the H.264 standard, the extended picture generated by the picture extension unit.

### BACKGROUND OF THE INVENTION

(1) Field of the Invention

The present invention is related to a picture coding device and the method thereof in which a high definition broadcast is coded according to the H.264 standard.

(2) Description of the Related Art

These days, digitalization of analog television broadcasts (SDTV: Standard Definition Television) has progressed, digital video recorders which record broadcasts into a hard disk or an optical disk, such as a Digital Versatile Disk-Random Access Memory (DVD-RAM) have become widely available, and furthermore, digital video recorders which can record satellite and terrestrial digital high definition broadcasts (HDTV: High Definition Television) have become commercially practical.

In HDTV broadcasting, a stream coded by the Moving Picture Experts Group 2 (MPEG2) standard is transmitted. When this is recorded, the MPEG2 stream itself is recorded. Alternatively, a recording method in which a decoded picture is converted to a picture size specified by the DVD standard and is recompressed by the MPEG2 standard is frequently used. In addition, there is another recording method in which the picture size of the HDTV remains unchanged and picture quality loss is reduced by lowering the bit rate using the H.264 standard which has higher coding efficiency than the MPEG2.

Regarding picture size in HDTV, a picture includes 1920 or 1440 horizontal pixels and 1080 valid lines. In the case where an original picture with the same size as a picture of the HDTV is coded, since the coding specified by the H. 264 standard is applied to a picture in which the number of the pixels and the number of lines are multiples of 16, it is necessary to consider an extended picture in which the number of valid lines increases to 1088.

Other than this case, the same types of picture extension are used, when coded blocks, which are in proper alignment, are deliberately misaligned, in order to make, for example, not-too-obvious block noise in the coded picture.

Japanese Laid-Open Patent Application No. 1-168165 (hereinafter referred to as Patent Reference 1) discloses one coding technology to code picture data including picture extension. The outline is: when a portion which is less than a macroblock is positioned in an end of a picture, virtual pixels are added to the portion so as to generate a block, and then the block is coded. Patent Reference 1 specifically describes that a pixel value of a pixel positioned in the farthest end of the picture may be used as a pixel value of the virtual pixels.

However, when the picture extension according to the conventional technology is simply applied to coding picture data using the H. 264 standard, there is a problem that preferable coding efficiency can not be obtained in an extended portion. Such a problem is caused by the fact that picture extension according to the conventional technology is not necessarily effective at reducing prediction errors when the intra prediction coding and inter prediction coding specified in the H. 264 standard are performed.

The present invention has been conceived in view of the aforementioned problem, and the object of the present invention is to provide, in a coding process including picture extension of picture data, a picture coding device which reduces the increase of the amount of coded data to be generated.

### SUMMARY OF THE INVENTION

In order to solve the aforementioned problem, the picture coding device according to the present invention includes: a coding unit that generates, by predicting an extended picture, a code which represents the extended picture, the extended picture being obtained by extending an input picture to a size which is a natural number times of a coding block; and a control unit that controls the coding unit so as to generate a code which represents a prediction error in lines which are extended from the input picture with 0, the lines being a part of the extended picture.

Furthermore, the control unit includes a picture extension unit that generates the extended picture by extending the input picture using a reference value defined to be used when adjacent pixels do not exist in performing intra prediction according to the H.264 standard, regardless of a pixel value included in the input picture, and the coding unit may generate a code which represents a prediction error in the extended lines with 0 by coding, using intra prediction according to the H.264 standard, the extended picture generated by the picture extension unit.

Furthermore, the input picture has 1080 lines, and the picture extension unit may generate an extended picture having 1088 lines by extending the input picture upward by 8 lines, using a pixel value of 128.

Furthermore, the control unit further includes a picture extension parameter output unit that outputs a picture extension parameter indicating whether the extended lines are positioned in the upper side or lower side of the input picture, and the picture extension unit may extend, in the case where the picture extension parameter indicates that the extended lines are positioned in the upper side of the input picture, the input picture upward using the reference value defined to be used when adjacent pixels do not exist in performing intra prediction according to the H.264 standard, regardless of a pixel value included in the input picture, and may extend, in the case where the picture extension parameter indicates that the extended lines are positioned in the lower side of the input picture, the input picture downward using a pixel value in the lowest-order line of the input picture.

Furthermore, the control unit further includes a picture extension parameter output unit that outputs a picture extension parameter indicating whether the input picture is a moving picture made up of a frame or a field, and in the case where the picture extension parameter indicates that the input picture is a frame, the picture extension unit may extend the input picture by the number of lines twice as many as the number of lines by which the input picture is extended in the case where the picture extension parameter indicates that the input picture is a field.

Furthermore, it is possible that the coding unit codes the extended picture using one of intra prediction and inter prediction, the control unit further includes a picture extension parameter output unit that outputs a picture extension parameter indicating which of the intra prediction and the inter prediction is used when the coding unit codes the extended picture, and the picture extension unit may extend, in the case where the picture extension parameter indicates that the intra prediction is used, the input picture using the reference value defined to be used when adjacent pixels do not exist in performing the intra prediction according to the H.264 standard, regardless of a pixel value included in the input picture, and may extend, in the case where the picture extension parameter indicates that the inter prediction is used, the input picture using a pixel value of extended lines of a reference picture used for the inter prediction.

Furthermore, the control unit includes a picture extension parameter output unit that outputs a picture extension parameter indicating a position of the extended lines with respect to the input picture and the number of lines included in the extended lines, and the coding unit includes a 0 value generation unit that generates a value of 0 as a prediction error in the extended lines indicated by the picture extension parameter, and may generate a code by coding the generated value of 0 and a prediction error related to the input picture according to the H.264 standard, the code representing the prediction error in the extended lines with 0.

Furthermore, the coding unit may code, as respectively different coding blocks, the value of 0 in the extended lines and the prediction error related to the input picture.

Note that it is not only possible to embody the present invention as the above-described picture coding device, but also as a picture coding method which includes, as the steps, the processing executed by the characteristic units included in such picture coding device, as well as an integrated circuit device for picture coding processing.

The picture coding device according to the present invention codes the extended picture obtained by extending an input picture using a reference value defined to be used when adjacent pixels do not exist in performing intra prediction according to the H. 264 standard, or generates a code that represents a prediction error in the extended lines of the extended picture with 0, by inserting a value of 0 as the prediction error of the extended lines. Thus, the amount of coded data to be generated is reduced. As a result, it is possible to obtain more preferable coding efficiency than the conventional cases.

Further Information about Technical Background To this Application

The disclosure of Japanese Patent Application No. 2005-317366 filed on Oct. 31, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing an example of the picture coding device according to the first embodiment.

FIG. 2 is a diagram showing a schematic representation of an example of picture extension performed in the upper side of the input picture.

FIG. 3 is a diagram showing a schematic representation of an example of picture extension performed in the lower side of the input picture.

FIG. 4 is a block diagram showing an example of the coding unit according to the first embodiment.

FIG. 5 is a diagram describing the intra prediction mode.

FIGS. 6A and 6B are diagrams describing the unit size of motion compensation.

FIG. 7 is a flowchart showing an example of the processing for determining the number of lines to be extended.

FIG. 8 is a flowchart showing an example of the picture extension processing on the input picture.

FIG. 9 is a flowchart showing another example of the extension processing on the input picture.

FIG. 10 is a block diagram showing an example of the picture coding device according to the second embodiment.

FIG. 11 is a block diagram showing an example of the coding unit according to the second embodiment.

FIG. 12 is a diagram showing an example of a schematic representation in coding the extended picture which is extended upward.

FIG. 13 is a diagram showing an example of a schematic representation in coding the extended picture which is extended downward.

### DESCRIPTION OF THE PREFERRED EMBODIMENT(S)

Preferred embodiments of the present invention will hereinafter be described with reference to the attached diagrams.

### First Embodiment

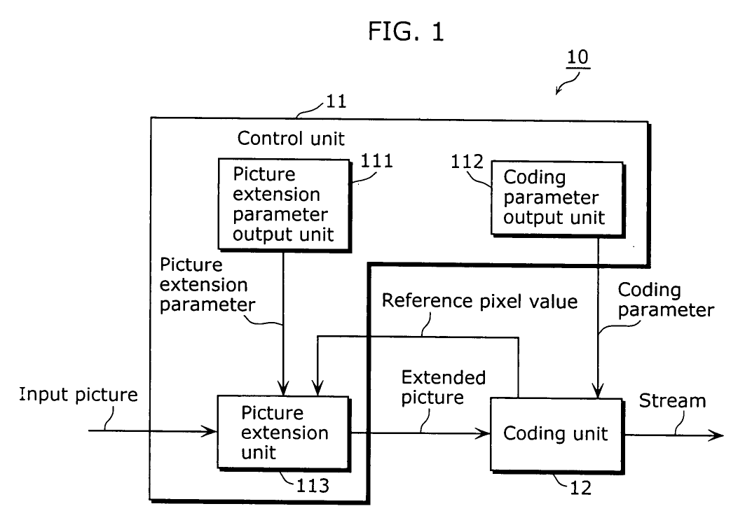

FIG. 1 is a block diagram showing one of the functional configurations of a picture coding device 10 according to the first embodiment of the present invention.

The picture coding device 10 is a device which generates a code that represents a prediction error in the extended lines of the extended picture with 0, by coding the extended picture obtained by extending an input picture using a reference value defined to be used when adjacent pixels do not exist in performing intra prediction according to the H. 264 standard, and includes a control unit 11 and a coding unit 12. The control unit 11 includes a picture extension parameter output unit 111, a coding parameter output unit 112, and a picture extension unit 113.

The control unit 11 and the coding unit 12 may function as software implemented by causing a computer to execute a program, and may be a circuit block made up of an integrated circuit device. Furthermore, an input picture may be an HDTV picture represented by a resolution of 1080i.

The picture extension parameter output unit 111 of the control unit 11 outputs a picture extension parameter including information indicating one of the following: (A) whether the extended lines are positioned in the upper side or lower side of the input picture; (B) whether the input picture is a moving picture made up of a frame or a field; and (C) which prediction the coding unit 12 uses when coding the extended picture, intra prediction or inter prediction.

Other than these, this picture extension parameter may include information indicating which method is used for representing an input picture, either YUV 422 which defines an input picture having the same number of luminance pixels and chrominance pixels, or YUV 420 which defines an input picture having the luminance pixels, and the chrominance pixels with half as many as the number of the luminance pixels.

The details of this picture extension parameter are determined, for example, based on the information instructed by an unillustrated user.

The picture extension unit 113 generates an extended picture by extending an input picture based on a picture extension parameter. The details of this extension processing are to be described hereinafter.

The coding parameter output unit 112 outputs a coding parameter including information indicating which prediction the coding unit 12 uses when coding the extended picture, intra prediction or inter prediction. Other than those, the coding parameter may include compression rate information which specifies a coding rate and mode information related to a prediction direction in intra prediction.

The coding unit 12 generates a stream including a code representing a picture by coding the extended picture based on a coding parameter, and outputs a reference pixel value to the picture extension unit 113. This reference pixel value is a pixel value compared to a pixel in another coding block in intra prediction, or a pixel value compared to a pixel in another frame or field in inter prediction (in other words, the prediction between frames or between fields).

Next, the picture extension processing performed by the picture extension unit 113 is described.

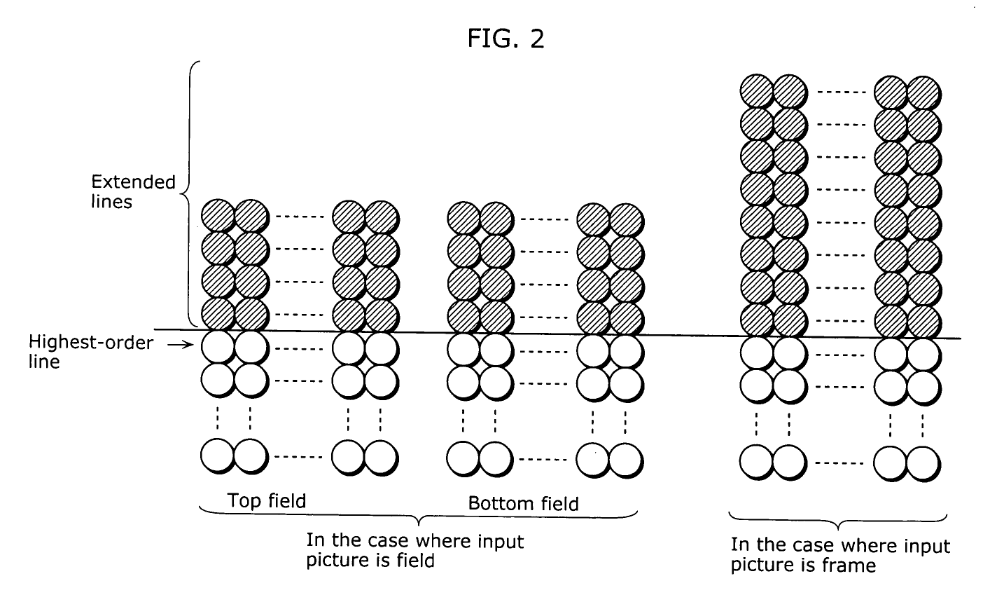

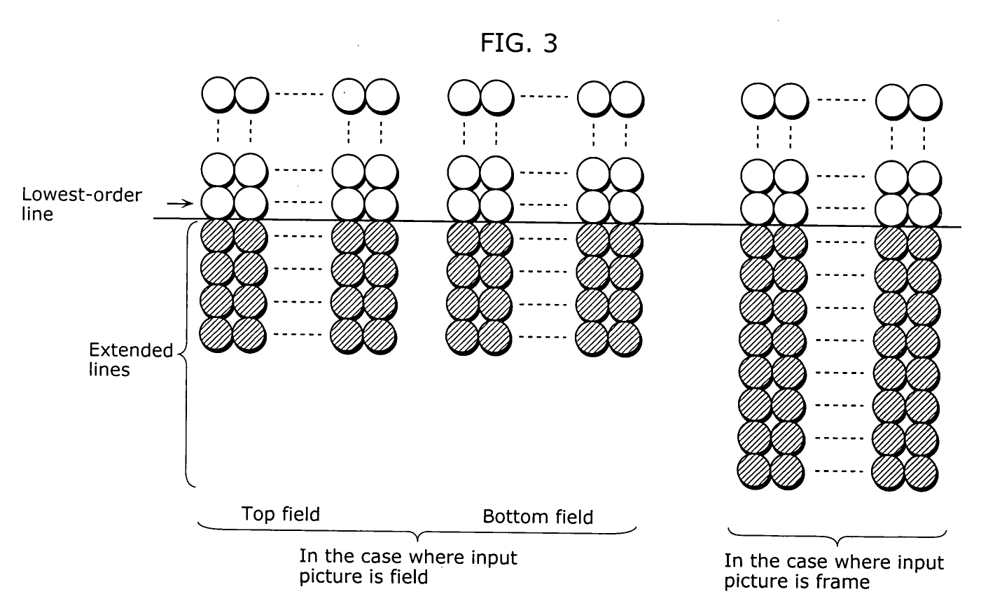

FIG. 2 and FIG. 3 are diagrams showing the schematic representations of examples of the picture extension processing.

A picture extension parameter is given from the picture extension parameter output unit 111 to the picture extension unit 113. Depending on the details of the picture extension parameter, an input picture is extended to a predetermined direction by a predetermined number of lines using a predetermined pixel value.

FIG. 2 shows an example which obtains the extended picture by extending the input picture upward by 8 lines. More specifically, this example is applied in the case where an input picture having 1080 lines is extended to a size of an extended picture having 1088 lines.

In the case where an input picture is a top field or a bottom field respectively having 540 lines and made up of a frame, as shown in the left side of FIG. 2, by extending the input picture by 4 lines in each field, the picture extension unit 113 extends the input picture by 8 lines per frame. In the case where an input picture is a frame having 1080 lines, as shown in the right side of FIG. 2, the picture extension unit 113 extends the input picture by 8 lines.

In other words, in the case where the input picture is a frame, the picture extension unit 113 extends the input picture by the number of lines twice as many as the number of lines by which the input picture is extended in the case where the input picture is a field.

Furthermore, in the case where the coding unit 12 uses intra prediction for coding the extended picture, the picture extension unit 113 designates a reference value of 128, defined to be use when adjacent pixels do not exist in performing intra prediction according to the H. 264 standard, as a pixel value of the extended lines. In the case where the coding unit 12 uses inter prediction for coding the extended picture, the picture extension unit 113 designates a reference pixel value given from the coding unit 12 as a pixel value of the extended lines.

FIG. 3 shows an example which obtains the extended picture by extending the input picture downward by 8 lines. The number of lines to be extended depending on whether the input picture is a field or a frame is the same as the aforementioned number of lines.

Furthermore, in the case where the coding unit 12 uses intra prediction for coding the extended picture, the picture extension unit 113 designates a pixel value in the lowest-order line of the input picture as a pixel value of the extended lines. In the case where the coding unit 12 uses inter prediction for coding the extended picture, the picture extension unit 113 designates a reference pixel value given from the coding unit 12 as a pixel value of the extended lines.

Note that the pixels are described up to this point without making a distinction between a luminance pixel representing luminance information and a chrominance pixel representing chrominance information. As an example, the aforementioned description applies to both luminance pixels and chrominance pixels of an input picture represented by YUV422. Furthermore, the aforementioned description also applies to luminance pixels of an input picture represented by YUV420, while a modification of the description in the case where an input picture is extended by half the number of lines applies to chrominance pixels of the input picture represented by YUV420.

Next, the details of the coding unit 12 are described.

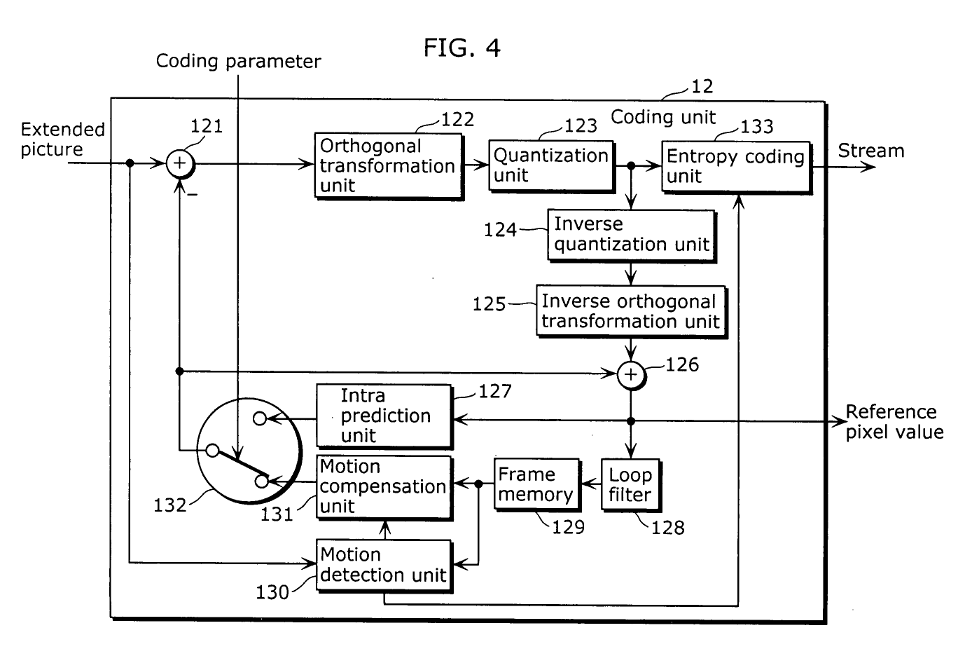

FIG. 4 is a block diagram showing one of the functional configurations of the coding unit 12. Since this configuration is well known as a general model of an encoder according to the H.264 standard, it is briefly described hereinafter.

The coding unit 12 codes, into a stream per macroblock which is a block on a per-coded basis, an extended picture outputted from the picture extension unit 113. The coding unit 12 performs one of the intra prediction and inter prediction depending on a coding parameter given from the coding parameter output unit 112.

An adding unit 121 calculates an error between a pixel value in an extended picture and a reference value used for prediction, an orthogonal transformation unit 122 transforms the error, for example, into a discrete cosine transform coefficient, and a quantization unit 123 quantizes the discrete cosine transform coefficient.

An inverse quantization unit 124 and an inverse orthogonal transformation unit 125 locally obtain an error equivalent to the error calculated by a reproduction device through decoding the result of the quantization. An adding unit 126 obtains a pixel value which has been locally decoded, by adding this error to the reference pixel value.

The pixel value obtained by the adding unit 126 is outputted to an intra prediction unit 127, stored in a frame memory 129 via a loop filter 128, and furthermore outputted to the picture extension unit 113.

In the case where intra prediction is used for coding, the intra prediction unit 127 generates a predetermined reference pixel value defined to be compared to an adjacent macroblock according to the H.264 standard based on the pixel value given from the adding unit 126.

Then, a switch 132 selects the reference pixel value generated from the intra prediction unit 127, and the adding unit 121 executes the subsequent coding by calculating an error between a pixel value of an adjacent macroblock included in the extended picture and the selected reference pixel value.

In the case where inter prediction is used for coding, a motion detection unit 130 calculates a motion vector of a macroblock in the extended picture representing a subsequent frame or a field, based on the reference pixel value stored in the frame memory 129 by calculating an error in a previous frame or field (in other words, a reference picture). A motion compensation unit 131 outputs, as a reference pixel value, a pixel value within a range represented by the motion vector calculated from the reference picture.

Then, the switch 132 selects the reference pixel value outputted from the motion compensation unit 131, and the adding unit 121 executes the subsequent coding by calculating an error between a pixel value of a macroblock in the subsequent frame or field and the selected reference pixel value.

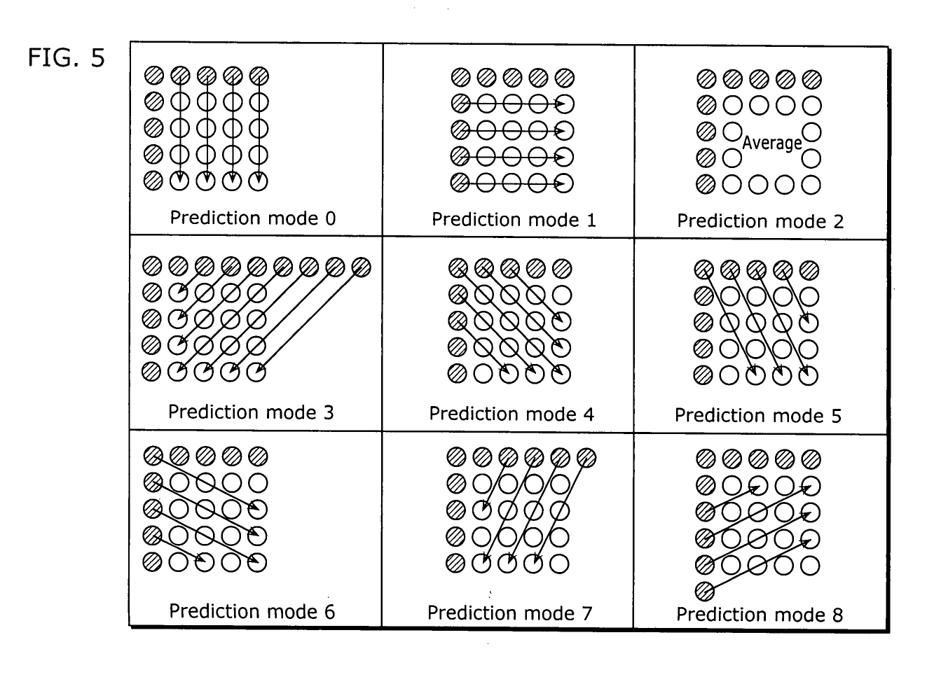

FIG. 5 is a diagram showing, according to the H.264 standard, reference pixels each defined to be used for finding a difference between pixels in a block which is an object of intra prediction. As shown in the diagram, the H.264 standard specifies 9 different prediction modes each of which finds differences between respective reference pixels which are positioned in point of origin of each arrow and respective pixels which are positioned in the direction of each of the arrow.

In this diagram, the size of a block is represented as 4×4 pixels as an example. In the diagram, the white circles represent pixels per block, and the diagonally shaded circles represent the reference pixels positioned in the left side of the block or in the upper part of the block.

In the prediction mode 0, respective differences between plural reference pixels positioned in the upper side of the block and each of the corresponding four pixels in the block are calculated.

In the prediction mode 1, respective differences between plural reference pixels in the left side of the block and each of the corresponding four pixels in the right side of each of the reference pixel in the block are calculated.

In the prediction mode 2, respective differences between each of the reference pixels and an average value of the pixels in the block are calculated.

In the prediction modes 3 to 8, respective differences between plural reference pixels and each of the corresponding four pixels in the block which are positioned in the direction of each arrow that is viewed from each reference pixel are calculated.

As there is no reference pixel positioned in the upper side of a block positioned in the upper end of a picture, one of the prediction modes 1, 2, and 8 is used. In particular, as there is no reference pixel in a block positioned in the upper left end of a picture, the prediction mode 2 is used on the assumption that the average value of the reference pixels is 128. This value of 128 is an example of reference values defined to be used when adjacent pixels do not exist in performing intra prediction according to the H. 264 standard.

Note that intra prediction can be performed on the blocks having the size of 8×8 pixels and 16×16 pixels.

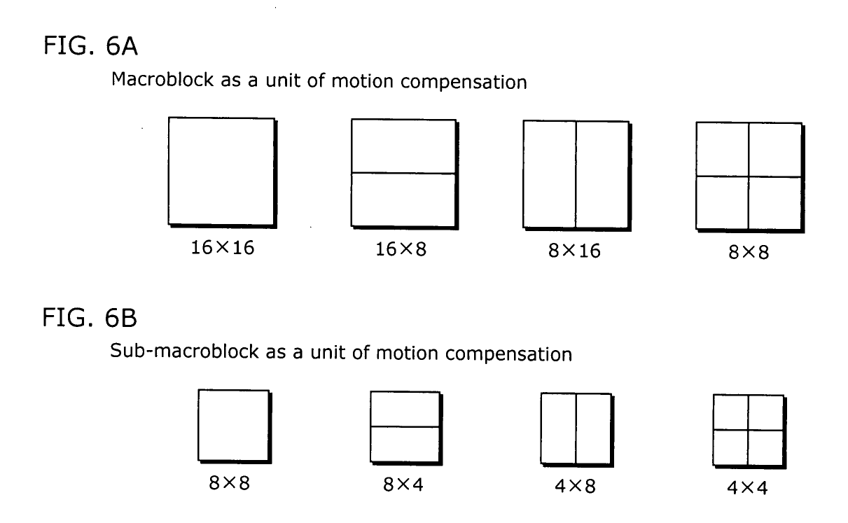

FIGS. 6A and 6B are diagrams showing units of motion compensation according to the H.264 standard. In the conventional MPEG standard, a macroblock with the size of 16×16 pixels is only used as a unit of motion compensation. However, in the H.264 standard, 4 different types of macroblocks are used as shown in FIG. 6A, namely, the macroblocks respectively using: one 16×16 pixel partition, two 16×8 pixel partitions, two 8×16 pixel partitions, and four 8×8 pixel partitions, and furthermore 3 different types of sub-macroblocks are used as shown in FIG. 6B, namely, the sub-macroblocks generated by dividing one 8×8 pixels, respectively using: two 8×4 pixel partitions, two 4×8 pixel partitions, and four 4×4 pixel partitions.

Next, the main part of the processing performed in the picture extension unit 113 is described with reference to the flow charts.

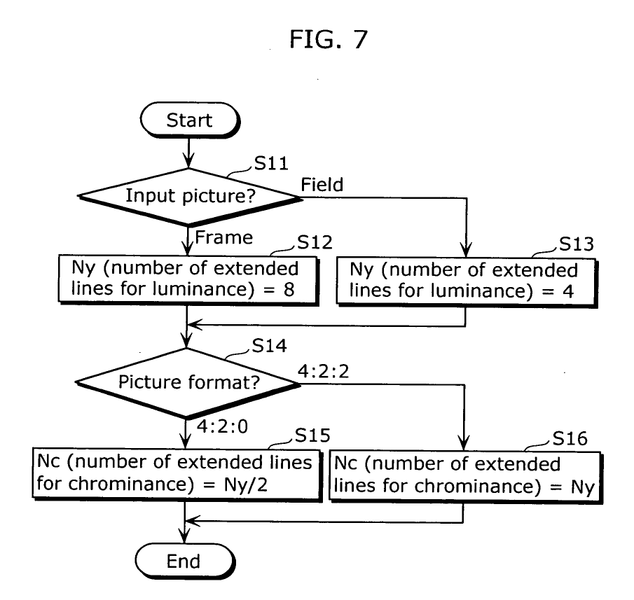

FIG. 7 is a flowchart showing an example of the processing for determining the number of lines to be extended.

In the case where a picture extension parameter given from the picture extension parameter output unit 111 indicates that the input picture is a frame (frame at S11), the picture extension unit 113 determines Ny (the number of extended lines for luminance) as 8 (S12), and in the case where the picture extension parameter indicates that the input picture is a field (field at S11), the picture extension unit 113 determines Ny as 4 (S13).

Next, in the case where the picture extension parameter indicates that the input picture is represented by YUV420 (4:2:0 at S14), the picture extension unit 113 determines Nc (the number of extended lines for chrominance) as Ny/2 (S15), and in the case where the picture extension parameter indicates the input picture is represented by YUV422 (4:2:2 at S14), the picture extension unit 113 determined Nc as Ny (S16).

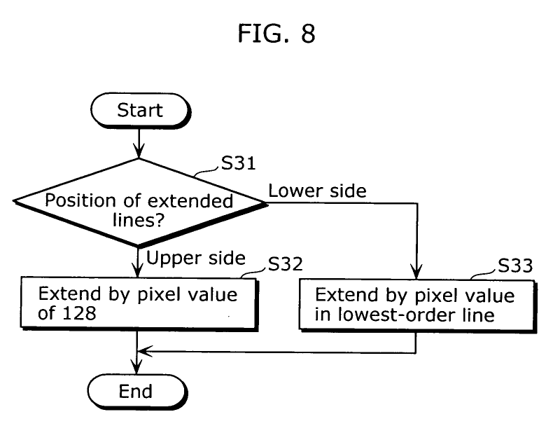

FIG. 8 is a flowchart showing an example of the picture extension processing.

In the case where the picture extension parameter indicates that the extended lines are in the upper side of the input picture (upper side at S31), the picture extension unit 113 generates an extended picture by extending the input picture using a pixel value of 128 upward by the number of lines determined according to the flowchart shown in FIG. 7 (S32 and FIG. 2). On the other hand, in the case where the picture extension parameter indicates that the extended lines are in the lower side of the input picture (lower side at S31), the picture extension unit 113 generates an extended picture by extending the input picture using a pixel value in the lowest-order line of the input picture downward by the number of lines determined in the aforementioned manner (S33 and FIG. 3).

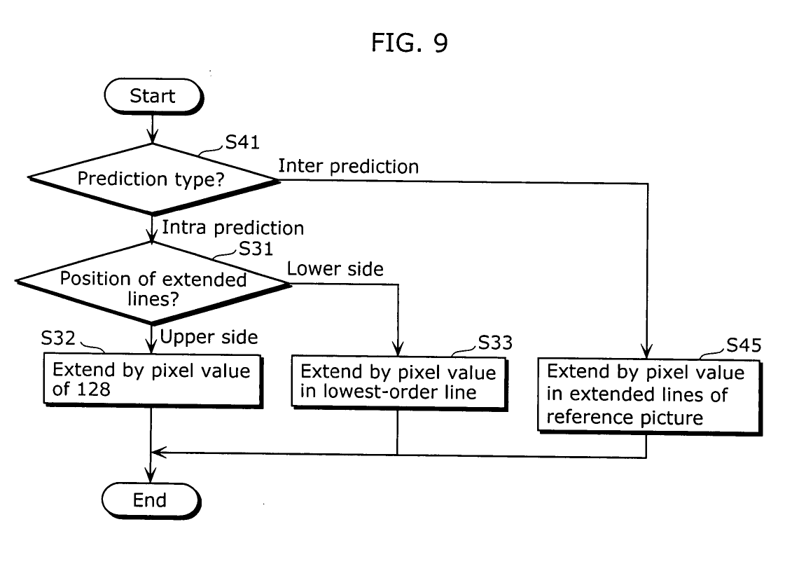

FIG. 9 is a flowchart which increases the processing shown in FIG. 8 so as to differentiate the processing using one of intra prediction and inter prediction as a prediction method.

In the case where the picture extension parameter given from the picture extension parameter output unit 111 indicates that intra prediction is used as a prediction method (intra prediction at S41), the picture extension unit 113 executes the processing shown in FIG. 8. On the other hand, in the case where the picture extension parameter indicates that inter prediction is used as the prediction method (inter prediction at S41), the picture extension unit 113 extends the input picture using a reference pixel value given from the coding unit 12 (S42). In this case, the direction and the number of lines to be extended conform to the picture extension parameter and the determined number of lines.

In the aforementioned configuration, in the case where the extended picture generated by extending the input picture upward using the pixel value of 128 is coded using intra prediction, the prediction error becomes 0 in the extended lines because intra prediction is performed on the macroblocks at the upper left end of the picture using the pixel value of 128. Furthermore, as intra prediction is performed on other macroblocks positioned in the upper end of the picture using the pixel value of a pixel adjacent to the left side, the prediction error becomes 0 in the extended lines.

In the case where the extended picture generated by extending the input picture downward using the pixel value in the lowest-order line of the input picture is coded using intra prediction, the prediction error becomes 0 in the extended lines because the prediction is performed on the macroblocks positioned in the lower end of the screen using the pixel value of pixels on the macroblocks.

On the other hand, even when the extended picture extended using the reference pixel value (in other words, a pixel value of the reference picture) given from the coding unit 12 is coded using inter prediction in which the motion vector is 0, the prediction error can be 0. In that case, it is preferable to code, as respectively different coding blocks, the extended lines and other potions in the extended picture by selecting, for example as a motion compensation unit, a macroblock using two 16×8 pixel partitions or a sub-macroblock using two 8×4 pixel partitions. With this, since only a code representing a coding condition is required in the extended lines, it is possible to largely reduce the amount of coded data to be generated.

### Second Embodiment

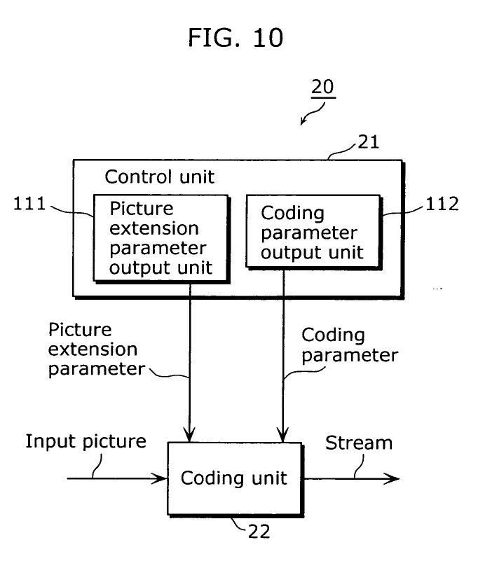

FIG. 10 is a block diagram showing one of the functional configurations of a picture coding device 20 according to the second embodiment of the present invention.

The picture coding device 20 is a device which generates a value of 0 as a prediction error in the extended lines generated by extending an input picture and to be a part of the extended picture and which generates a code which represents the prediction error in the extended lines with 0 by coding the generated value of 0 and the prediction error related to the input picture according to the H.264 standard. Compared to the picture coding device 10, the picture coding device 20 includes a control unit 21 in which the picture extension unit 113 is omitted, and a coding unit 22 in which the details are different from the coding unit 12.

As the first embodiment, the control unit 21 and coding unit 22 may function, for example, as software implemented by causing a computer to execute a program, and as a circuit block made up of an integrated circuit device. Furthermore, an input picture may be an HDTV picture represented by a resolution of 1080i.

The description of the units is hereinafter omitted by using the same unit numbers for the units having the same configuration as the units in the picture coding device 10 described in the first embodiment.

The control unit 21 outputs, to the coding unit 22, a picture extension parameter and a coding parameter similar to those of the first embodiment.

This picture extension parameter in the second embodiment is different from that of the first embodiment in that it is used only for determining the position of the extended lines with respect to the input picture and the number of lines included in the extended lines. Specific pixel values to be inputted into the coding unit 22 are never generated in the determined extended lines.

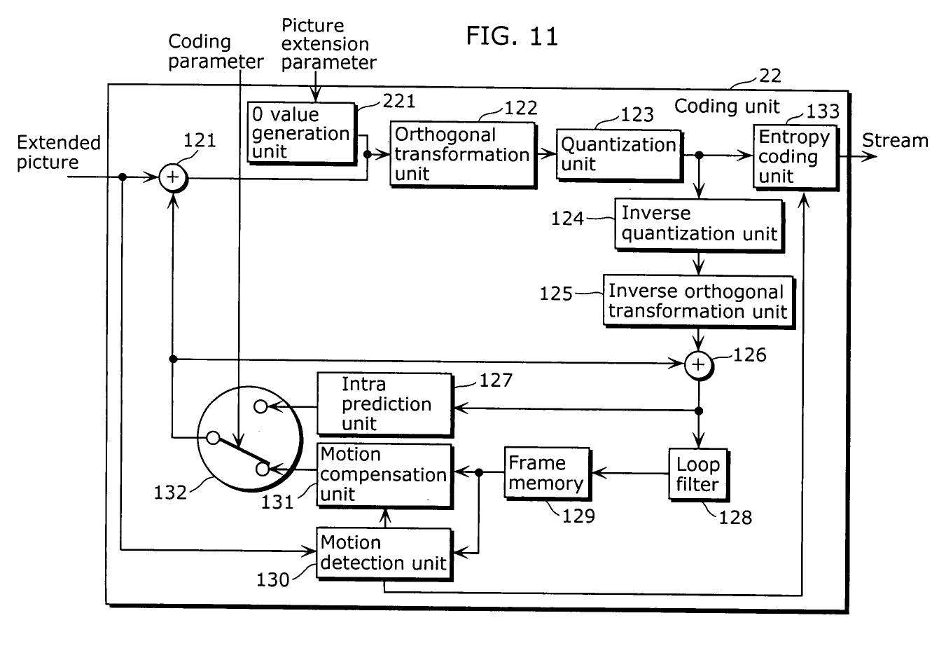

FIG. 11 is a block diagram showing one of the functional configurations of the coding unit 22. The coding unit 22 includes a 0 value generation unit 221 which generates a value of 0 as a prediction error in the extended lines, and codes the generated value of 0 and the prediction error related to the input picture according to the H.264 standard.

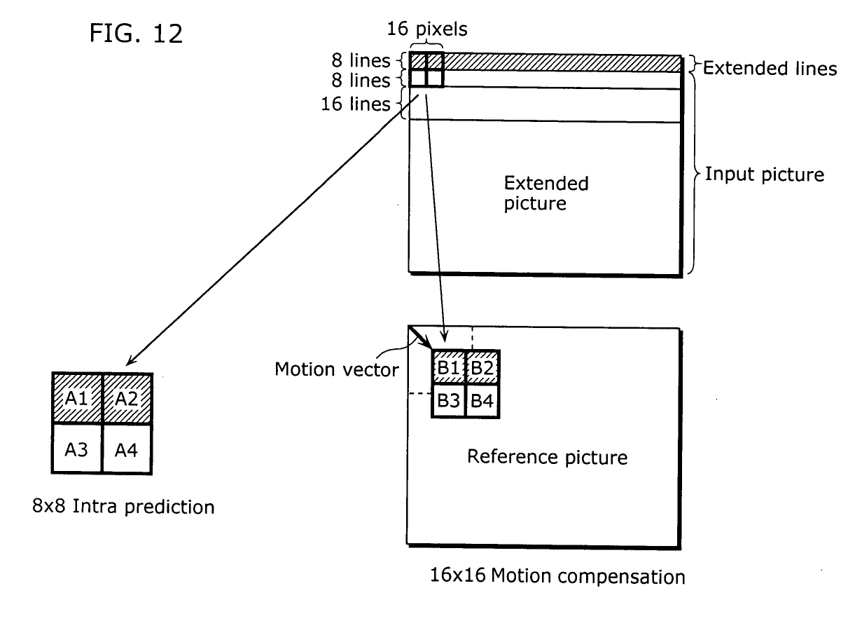

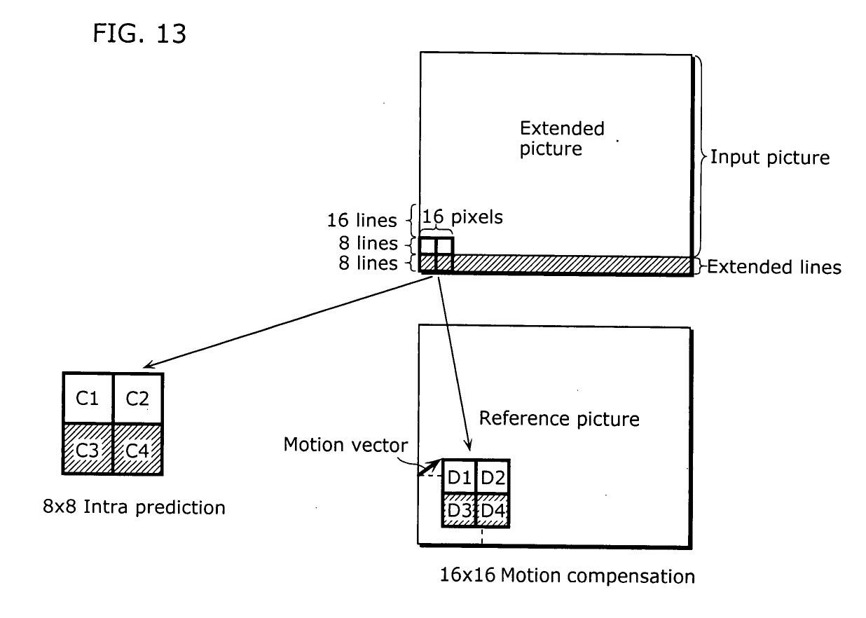

FIG. 12 and FIG. 13 are diagrams showing the schematic representations of examples of the coding processing.

FIG. 12 shows an example in the case where the extended 8 lines are added in the upper side of the input picture.

As shown in the diagram, the macroblock at the upper end of the screen becomes an area in which the above 8 lines are to be extended. Assume the extended macroblock which includes the extended lines of the macroblock as dummy data (don't care values), the following coding is performed.

The intra prediction unit 127 generates respective evaluation values for each 9 different modes described in FIG. 5 according to the H.264 standard, selects the best mode judging from among the generated evaluation values, and performs intra prediction with the selected mode. For example, assuming the prediction error as an evaluation value represented by a sum of absolute difference between the reference picture and the corresponding pixel of the macroblock, the intra prediction unit 127 selects a mode in which this evaluation value becomes the minimal value.

In particular, when performing intra prediction on the extended macroblock, the intra prediction unit 127 evaluates prediction errors of the extended lines A1 and A2 compulsively as 0 and determines the mode. In intra prediction, as long as: the average value prediction (prediction mode 2) using a pixel value of 128 is available to a block positioned in the upper left end of a picture; the prediction modes 1, 2, and 8 are available to a block positioned in the upper end other than the blocks positioned in the upper left end; and the prediction mode corresponding to the prediction mode having the minimal number selected in the adjacent block is represented by 1 bit, for example, it is preferable to select the prediction mode 2 for all of the extended macroblocks for reducing the amount of coded data.

Furthermore, the motion detection unit 130 and motion compensation unit 131 generate evaluation values for each unit size of the motion compensation shown in FIGS. 6A and 6B, select a motion unit size having the best evaluation value, and apply motion compensation with the selected unit size. For example, assuming that the prediction error represented by a sum of absolute difference between the reference picture and the corresponding pixel of the macroblock as an evaluation value, the motion detection unit 130 and motion compensation unit 131 select a unit size in which this evaluation value becomes the minimal value.

In particular, when performing inter prediction on the macroblock to be extended, the motion detection unit 130 and motion compensation unit 131 evaluate prediction errors of the extended lines B1 and B2, assuming that the errors are compulsively 0, and select the unit size for motion compensation.

As an example, in the case of selecting 16×16 pixels as a unit size, the motion detection unit 130 calculates an evaluation value, assuming that the prediction errors of the block B1 and B2 in the upper end as 0. In other words, this evaluation value is calculated only using the prediction errors of B3 and B4 blocks at the lower end in the macroblock to be extended.

As another example, in the case of selecting a macroblock of two 16×8 pixel partitions as a unit size, the motion detection unit 130 represents the prediction errors of the blocks positioned in the extended lines with 0, and defines a motion vector so as to be represented by the least amount of coded data. As long as the motion vector is represented by the difference between the motion vector and a prediction vector generated from among adjacent motion vectors, it is preferable that the difference vector is represented with 0, assuming that the motion vector is equal to the prediction vector so as to reduce the amount of coded data.

Then, the intra prediction mode determined in the aforementioned manner, the prediction error calculated in each block of the input picture by the adding unit 121 according to the unit size of the motion compensation and the motion vector, and the value of 0 generated in the 0 value generation unit 221 in respond to the blocks A1, A2, B1, and B2 in the extended lines are coded into a stream by the orthogonal transformation unit 122, the quantization unit 123, and the entropy coding unit 133.

FIG. 13 shows an example in the case where the extended 8 lines are added in the lower side of the input picture.

As shown in the diagram, the macroblock at the lower end of the screen becomes an area in which the above 8 lines are to be extended. The following coding is performed, assuming that the extended macroblock uses arbitrary (“don't care”) pixel values in the extended lines. The basic coding procedure is similar to the one used when the extended lines shown in FIG. 12 are added in the upper side of the input picture.

When performing intra prediction on the macroblock to be extended, the intra prediction unit 127 compulsively evaluates, as 0, prediction errors of the extended lines C3 and C4, and selects the respective prediction modes. In the block C3, a prediction mode having the minimal number is selected, either the prediction mode of the block C1 or the prediction mode 2. As there is no block to the left side of the block C3, this selection method is used. In the block C4, a prediction mode having the minimal number is selected, either the prediction mode of the block C2 or the prediction mode of the block C3.

Furthermore, the motion detection unit 130 and motion compensation unit 131 perform inter prediction, assuming the prediction errors of the blocks D3 and D4 positioned in the lower side of the input picture compulsively as 0, in contrast to the extension upward, selects the unit size of the motion compensation, and calculates the motion vector.

Then, the intra prediction mode determined in the aforementioned manner, the prediction error calculated in each block of the input picture by the adding unit 121 according to the unit size of the motion compensation and the motion vector, and the value of 0 generated in the 0 value generation unit 221 in respond to the blocks C3, C4, D3, and D4 in the extended lines are coded into a stream by the orthogonal transformation unit 122, the quantization unit 123, and the entropy coding unit 133.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The picture coding device and the method thereof according to the present invention can be applied to devices which code pictures using intra prediction and inter prediction, and in particular to the use when HDTV pictures represented by a resolution of 1080i are coded according to the H.264 standard.

What is claimed is:

1. A picture coding device comprising:
a coding unit operable to generate, by predicting an extended picture, a code which represents the extended picture, the extended picture being obtained by extending an input picture to a size which is a natural number times of a coding block; and
a control unit operable to control said coding unit so as to generate a code which represents a prediction error in lines which are extended from the input picture with 0, the lines being a part of the extended picture.

2. The picture coding device according to claim 1,
wherein said control unit includes a picture extension unit operable to generate the extended picture by extending the input picture using a reference value defined to be used when adjacent pixels do not exist in performing intra prediction according to the H.264 standard, regardless of a pixel value included in the input picture, and
said coding unit is operable to generate a code which represents a prediction error in the extended lines with 0 by coding, using intra prediction according to the H.264 standard, the extended picture generated by said picture extension unit.

3. The picture coding device according to claim 2,
wherein the input picture has 1080 lines, and
said picture extension unit is operable to generate an extended picture having 1088 lines by extending the input picture upward by 8 lines, using a pixel value of 128.

4. The picture coding device according to claim 2,
wherein said control unit further includes a picture extension parameter output unit operable to output a picture extension parameter indicating whether the extended lines are positioned in the upper side or lower side of the input picture, and
said picture extension unit is operable to extend, in the case where the picture extension parameter indicates that the extended lines are positioned in the upper side of the input picture, the input picture upward using the reference value defined to be used when adjacent pixels do not exist in performing intra prediction according to the H.264 standard, regardless of a pixel value included in the input picture, and to extend, in the case where the picture extension parameter indicates that the extended lines are positioned in the lower side of the input picture, the input picture downward using a pixel value in the lowest-order line of the input picture.

5. The picture coding device according to claim 2,
wherein said control unit further includes a picture extension parameter output unit operable to output a picture extension parameter indicating whether the input picture is a moving picture made up of a frame or a field, and
in the case where the picture extension parameter indicates that the input picture is a frame, said picture extension unit is operable to extend the input picture by the number of lines twice as many as the number of lines by which the input picture is extended in the case where the picture extension parameter indicates that the input picture is a field.

6. The picture coding device according to claim 2,
wherein said coding unit is operable to code the extended picture using one of intra prediction and inter prediction,
said control unit further includes a picture extension parameter output unit operable to output a picture extension parameter indicating which of the intra prediction and the inter prediction is used when said coding unit codes the extended picture, and
said picture extension unit is operable to extend, in the case where the picture extension parameter indicates that the intra prediction is used, the input picture using the reference value defined to be used when adjacent pixels do not exist in performing the intra prediction according to the H.264 standard, regardless of a pixel value included in the input picture, and to extend, in the case where the picture extension parameter indicates that the inter prediction is used, the input picture using a pixel value of extended lines of a reference picture used for the inter prediction.

7. The picture coding device according to claim 1,
wherein said control unit includes a picture extension parameter output unit operable to output a picture extension parameter indicating a position of the extended lines with respect to the input picture and the number of lines included in the extended lines, and
said coding unit includes a 0 value generation unit operable to generate a value of 0 as a prediction error in the extended lines indicated by the picture extension parameter, and is operable to generate a code by coding the generated value of 0 and a prediction error related to the input picture according to the H.264 standard, the code representing the prediction error in the extended lines with 0.

8. The picture coding device according to claim 7,
wherein said coding unit is operable to code, as respectively different coding blocks, the value of 0 in the extended lines and the prediction error related to the input picture.

9. An integrated circuit device comprising:
a coding circuit which generates, by predicting an extended picture, a code that represents the extended picture, the extended picture being obtained by extending an input picture to a size which is a natural number times of a coding block; and
a control circuit which controls said coding circuit so as to generate a code which represents a prediction error in lines which are extended from the input picture with 0, the lines being a part of the extended picture.

10. A picture coding method for coding a picture, said method comprising:
a coding step of generating, by predicting an extended picture, a code that represents the extended picture, the extended picture being obtained by extending an input picture to a size which is a natural number times of a coding block; and
a control step of controlling said coding step so as to generate a code which represents a prediction error in lines which are extended from the input picture with 0, the lines being a part of the extended picture.

11. A computer-executable program for coding a picture, said program causing a computer to execute comprising:
a coding step of generating, by predicting an extended picture, a code that represents the extended picture, the extended picture being obtained by extending an input picture to a size which is a natural number times of a coding block; and
a control step of controlling said coding step so as to generate a code which represents a prediction error in lines which are extended from the input picture with 0, the lines being a part of the extended picture.
